(19) United States
(12) Patent Application Publication
(10) Pub. No.: US 2023/0387579 A1
(43) Pub. Date: Nov. 30, 2023

(54) ANTENNA

(71) Applicant: Dongguan Luxshare Technologies Co., Ltd, Dongguan City (CN)

(72) Inventor: Kang HE, Dongguan City (CN)

(73) Assignee: Dongguan Luxshare Technologies Co., Ltd, Dongguan City (CN)

(21) Appl. No.: 18/114,440

(22) Filed: Feb. 27, 2023

(30) Foreign Application Priority Data
May 26, 2022 (CN) 202210588838.1

(51) Int. Cl. H01Q 1/42

(52) U.S. Cl. CPC H01Q 1/42

(57) ABSTRACT

Provided is an antenna. The antenna includes a bottom case, a cover body, a first sealing member, and an antenna body. One of the bottom case and the cover body is provided with an annular recess, and the other of the bottom case and the cover body is provided with an annular ring. When the cover body covers the bottom case, the annular ring is inserted in the annular recess. A mounting cavity is formed between the cover body and the bottom case. The first sealing member is disposed within the annular recess and is formed by solidification of an adhesive. The antenna body is disposed within the mounting cavity and is electrically and/or communicatively connected to an external component via a cable.

### CROSS-REFERENCE TO RELATED APPLICATION

This application claims priority to Chinese Patent Application No. CN 2022105888381 filed with the CNIPA on May 26, 2022, the disclosure of which is incorporated herein by reference in its entirety.

### TECHNICAL FIELD

The present disclosure relates to the technical field of signal transceiving and, in particular, an antenna.

### BACKGROUND

An antenna is a converter that converts a guided wave propagating on a transmission line into an electromagnetic wave propagating in an unbounded medium (usually a free space), or converts inversely, and is a component used for transmitting or receiving the electromagnetic wave in radio equipment.

The antenna is used in a relatively complicated ambient. Usually, it is needed to consider the waterproof and dustproof performance. Therefore, in general, the antenna uses a component of a sealing ring, resulting in an increased number of parts and components, further causing the antenna to be complicated in the waterproof structure and be difficult to process, and ultimately leading to an increase in production costs.

### SUMMARY

The present disclosure provides an antenna to solve the problem that the waterproof structure of the antenna is complicated due to the introduction of a sealing ring in the existing art.

To achieve the preceding object, the present disclosure adopts the solutions below.

The present disclosure provides an antenna. The antenna includes a bottom case, a cover body, a first sealing member, and an antenna body.

One of the bottom case and the cover body is provided with an annular recess, and the other of the bottom case and the cover body is provided with an annular ring. When the cover body covers the bottom case, the annular ring is inserted in the annular recess. A mounting cavity is formed between the cover body and the bottom case.

The first sealing member is disposed within the annular recess and is formed by solidification of an adhesive.

The antenna body is disposed within the mounting cavity and is electrically and/or communicatively connected to an external component via a cable.

In an embodiment, the cover body includes a base plate and an encircling plate encircling the outer periphery of the base plate. The annular ring is disposed on the base plate and is located within the encircling plate. When the cover body covers the bottom case. The encircling plate encircles the outer side of the bottom case.

In an embodiment, the base plate is provided with an adhesive encircling plate on the inner side of the annular ring. The adhesive encircling plate and the annular ring form an adhesive recess. The adhesive encircling plate is provided with a first cable hole extending through the adhesive encircling plate to the adhesive recess. The annular ring is provided with a second cable hole extending through the annular ring to the adhesive recess. The cable extends through the first cable hole, the adhesive recess, and the second cable hole from inside to outside in sequence. The adhesive recess is filled with a second sealing member.

In an embodiment, the bottom case is provided with a support member. When the cover body covers the bottom case, the adhesive encircling plate abuts the support member.

In an embodiment, the base plate is provided with a connection seat. The connection seat is disposed between the encircling plate and the annular ring and is provided with a screw hole. The bottom case is provided with a mounting hole. A set screw extends through the mounting hole and is screwed in the screw hole.

In an embodiment, the antenna also includes an attraction member disposed on the bottom case and capable of attracting an external component.

In an embodiment, the attraction member includes a magnet. A mounting recess is disposed on a side of the bottom case facing away from the cover body. The magnet is disposed within the mounting recess.

In an embodiment, the antenna also includes a waterproof film bonded to the bottom case and capable of covering and sealing the mounting recess and the mounting hole.

In an embodiment, the antenna body is secured to the base plate. A gap is reserved between the antenna body and the bottom case.

In an embodiment, the antenna also includes a buffer member. The cable extends through the buffer member. The bottom case includes a first fixing portion. The cover body is provided with a second fixing portion. When the cover body covers the bottom case. The buffer member is sandwiched between the first fixing portion and the second fixing portion.

### BRIEF DESCRIPTION OF DRAWINGS

FIG. 1 is a structure view of an antenna according to an embodiment of the present disclosure.

FIG. 2 is a view illustrating the internal structure of an antenna according to an embodiment of the present disclosure.

FIG. 3 is a partial enlarged view of part A of FIG. 2.

FIG. 4 is a structure view of a cover body according to an embodiment of the present disclosure.

FIG. 5 is a structure view of a bottom case from a first perspective according to an embodiment of the present disclosure.

FIG. 6 is a structure view of a bottom case from a second perspective according to an embodiment of the present disclosure.

FIG. 7 is a structure view of an antenna according to an embodiment of the present disclosure.

### REFERENCE LIST

100 cable
200 buffer member
1 bottom case
11 annular recess
111 guide tab
12 mounting hole
13 flange
14 support member
mounting recess
16 first fixing portion
2 cover body
21 annular ring
211 second cable hole
22 base plate
23 encircling plate
24 connection seat
adhesive encircling plate
251 first cable hole
26 second fixing portion
27 limiting member
3 first sealing member
4 antenna body
5 attraction member
6 waterproof film
7 second sealing member

### DETAILED DESCRIPTION

The solutions of the present disclosure are described clearly and completely hereinafter in conjunction with drawings. Apparently, the described embodiments are part, not all, of embodiments of the present disclosure.

In the description of the present disclosure, it is to be noted that orientations or position relations indicated by terms such as “center”, “upper”, “lower”, “left”, “right”, “vertical”, “horizontal”, “in”, and “out” are orientations or position relations based on the drawings. These orientations or position relations are intended only to facilitate the description of the present disclosure and simplify the description and not to indicate or imply that a device or element referred to must have such specific orientations or must be configured or operated in such specific orientations. Thus, these orientations or position relations are not to be construed as limiting the present disclosure. In addition, terms such as “first” and “second” are used merely for the purpose of description and are not to be construed as indicating or implying relative importance. Terms such as “first position” and “second position” are two different positions. Moreover, when the first feature is described as “on”, “above”, or “over” the second feature, the first feature is right on, above, or over the second feature, or the first feature is obliquely on, above, or over the second feature, or the first feature is simply at a higher level than the second feature. When the first feature is described as “under”, “below”, or “underneath” the second feature, the first feature is right under, below, or underneath the second feature, or the first feature is obliquely under, below, or underneath the second feature, or the first feature is simply at a lower level than the second feature.

In the description of the present disclosure, it is to be noted that, unless otherwise specified and limited, terms “mounted”, “joined”, and “connected” are to be understood in a broad sense unless otherwise expressly specified and limited. For example, the term “connected” may refer to “securely connected”, “detachably connected” or “integrated”, may refer to “mechanically connected” or “electrically connected”, or may refer to “connected directly”, “connected indirectly through an intermediary” or “connected inside two components”. For those of ordinary skill in the art, specific meanings of the preceding terms in the present disclosure may be construed based on specific situations.

The embodiments of the present disclosure are described in detail below, and examples of the embodiments are illustrated in the drawings. The same or similar reference numerals indicate the same or similar elements or elements having the same or similar functions. The embodiments described below with reference to the drawings are merely exemplary and intended to explain the present disclosure, and are not to be construed as limiting the present disclosure.

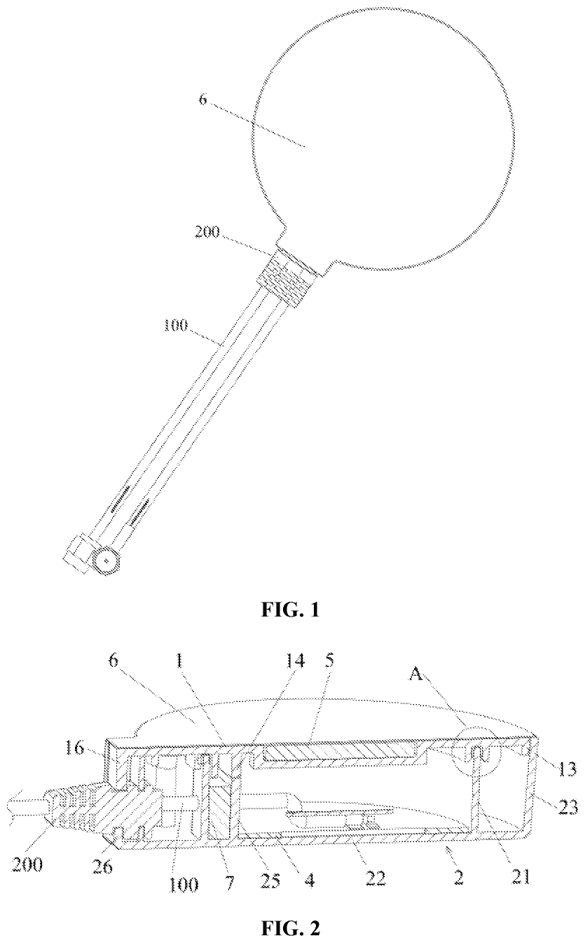

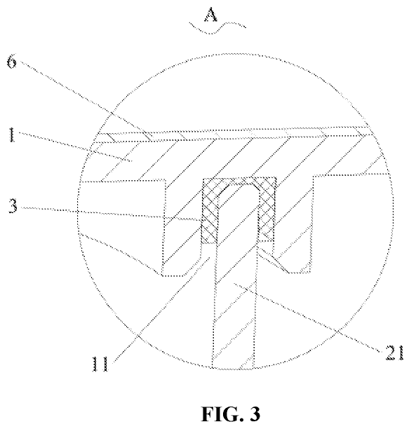

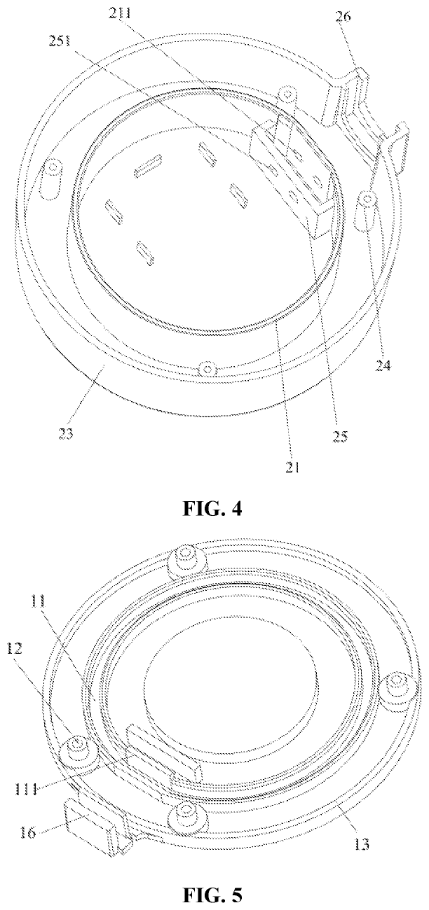

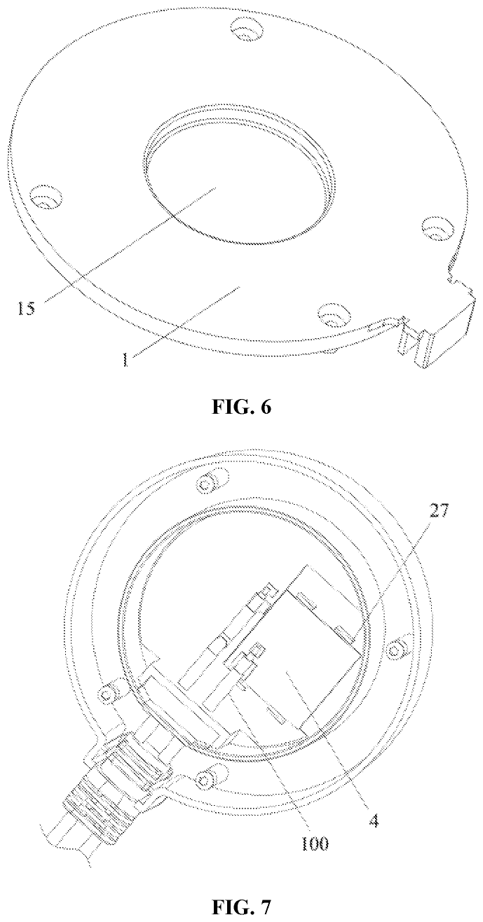

As shown in FIGS. 1 to 7, embodiments of the present disclosure provide an antenna. The antenna includes a bottom case 1, a cover body 2, a first sealing member 3, and an antenna body 4. One of the bottom case 1 and the cover body 2 is provided with an annular recess 11, and the other of the bottom case 1 and the cover body 2 is provided with an annular ring 21. When the cover body 2 covers the bottom case 1, the annular ring 21 is inserted in the annular recess 11. A mounting cavity is formed between the cover body 2 and the bottom case 1. The first sealing member 3 is disposed within the annular recess 11 and is formed by solidification of an adhesive. The antenna body 4 is disposed within the mounting cavity and is electrically and/or communicatively connected to an external component via a cable 100. With the arrangement of the preceding structure, the bottom case 1 and the cover body 2 can be directly sealed by the first sealing member 3 formed by solidification of the adhesive, avoiding using the sealing ring to seal. In this manner, the number of parts and components is reduced, the structure is simplified, the processing difficulty is reduced, and the manufacturing cost is reduced.

Optionally, a guide tab 111 is disposed on the inner sidewall of the annular recess 11 to play a role of guiding when the cover body 2 is mounted, facilitating improving the assembled efficiency. In addition, the guide tab 111 can play a splash-proof role when the adhesive is dripped here, and have a fool-proof effect.

As for the structure of the cover 2, in an embodiment, the cover body 2 includes a base plate 22 and an encircling plate 23 encircling the outer periphery of the base plate 22. The annular ring 21 is disposed on the base plate 22 and is located within the encircling plate 23. When the cover body 2 covers the bottom case 1, the encircling plate 23 encircles the outer side of the bottom case 1. In the preceding arrangement, since the bottom case 1 is housed by the encircling plate 23, when the bottom case 1 abuts the mounting structure, the cover 2 covers a side of the bottom case 1 facing away from the mounting structure and the periphery of the bottom case 1, thereby effectively preventing dust or water from entering the mounting cavity, and playing a dual role of waterproof and dustproof in conjunction with the preceding first sealing member 3, especially, having a good waterproof effect.

Optionally, the periphery of the base plate 22 is provided with an annular flange 13 for increasing the strength of the base plate 22 and capable of increasing the contact area between the base plate 22 and the encircling plate 23, further improving the waterproof and dustproof effect.

Optionally, the base plate 22 is provided with an adhesive encircling plate 25 on the inner side of the annular ring 21. The adhesive encircling plate 25 and the annular ring 21 form an adhesive recess. The adhesive encircling plate 25 is provided with a first cable hole 251 extending through the adhesive encircling plate 25 to the adhesive recess, and the annular ring 21 is provided with a second cable hole 211 extending through the annular ring 21 to the adhesive recess. The cable 100 extends through the first cable holes 251, the adhesive recess, and the second cable hole 211 from inside to outside in sequence. The adhesive recess is filled with a second sealing member 7. With such an arrangement, the cable 100 extending through the first cable hole 251 and the second cable hole 211 can be better sealed. Both the first sealing member 3 and the second sealing member 7 may be formed by solidification of a liquid adhesive, silica gel, rubber or plastic.

Since the second sealing member 7 is the solidified adhesive, if the second sealing member 7 is squeezed, cracks may occur on the second sealing member 7 or a gap may occur between the second sealing member 7 and the cable 100 or the sidewall of the adhesive recess, thereby causing the sealing effect to be weakened or even lost. To avoid this, in an embodiment, the bottom case 1 may be provided with a support member 14. When the cover body 2 covers the bottom case 1, the adhesive encircling plate 25 abuts the support member 14. With the arrangement of the preceding structure, when the cover body 2 is squeezed, the adhesive encircling plate 25 abuts the support member 14 so as to prevent the cover body 2 from having a large deformation at the adhesive recess, thereby ensuring the adhesive in the adhesive recess to be not squeezed, and facilitating ensuring the sealing effect.

To improve the firmness of the connection between the cover body 2 and the bottom case 1, in an embodiment, the base plate 22 may be provided with a connection seat 24. The connection seat 24 is disposed between the encircling plate 23 and the annular ring 21 and is provided with a screw hole. The bottom case 1 is provided with a mounting hole 12. A set screw extends through the mounting hole 12 and is screwed in the screw hole. The mounting hole 12 is a countersunk bore. The set screw is tightened when the adhesive of the first sealing member 3 is not completely solidified so that the cover body 2 and the bottom case 1 are connected mainly by the set screw. In this manner, the first sealing member 3 mainly plays the role of sealing, facilitating improving the duration of the sealing effect.

To facilitate securing the antenna to other components, in an embodiment, the antenna also includes an attraction member 5 disposed on the bottom case 1 and capable of attracting an external component. Specifically, the attraction member 5 includes a magnet. A mounting recess is disposed on a side of the bottom case 1 facing away from the cover body 2. The magnet is disposed within the mounting recess 15. The preceding arrangement can protect the magnet from being damaged by an impact.

In addition, the outer surface of the bottom case 1 is a flat surface after the magnet is mounted due to the arrangement of the mounting recess 15. Thus, in an embodiment, to prevent water vapor or dust from entering the mounting hole 12, the antenna may also include a waterproof film 6 bonded to the bottom case 1 and capable of covering and sealing the mounting recess 15 and the mounting holes 12. Optionally, the waterproof film 6 may be pasted to the bottom case 1. The pasted waterproof film 6 can seal the magnet within the mounting recess 15, thereby saving a securing member between the magnet and the non-metallic bottom case 1. Of course, the bottom of the bottom case may be made of a metal such as iron or steel that can be attracted by the magnet. In another embodiment, the magnet may be bonded in the mounting recess 15 of the non-metallic bottom case 1.

Optionally, the antenna body 4 is secured to the base plate 22. A gap is reserved between the antenna body 4 and the bottom case 1. The preceding arrangement can avoid the impact of the magnet on the antenna body 4 as much as possible. The base plate 22 is provided with a limiting member 27 for limiting the antenna body 4. Optionally, a plurality of limiting members 27 are provided. The antenna body 4 includes a printed circuit board (PCB) radiation antenna and a ceramic antenna. The PCB radiation antenna is provided with an avoidance recess. The projection of the radiation antenna on the base plate 22 is located within the projection of the avoidance recess on the base plate 22. The plurality of limiting members 27 abut the inner sidewall of the avoidance recess. The PCB radiation antenna and the ceramic antenna are each connected to a subminiature version A (SMA) connector through the cable 100.

In an embodiment, the antenna also includes a buffer member 200. The cable 100 extends through the buffer member 200. The bottom case 1 includes a first fixing portion 16. The cover body 2 is provided with a second fixing portion 26. When the cover body 2 covers the bottom case 1, the buffer member 200 is sandwiched between the first fixing portion 16 and the second fixing portion 26. With such an arrangement, the cable 100 can be protected by the buffer member 200 when bent, thereby improving the durability of the cable 100.

Apparently, the preceding embodiments of the present disclosure are merely illustrative of the present disclosure and are not intended to limit the implementations of the present disclosure. For those of ordinary skill in the art, changes or alterations in other different forms may also be made based on the preceding description. All implementations cannot be and do not need to be exhausted herein.

What is claimed is:

1. An antenna, comprising:
a bottom case;
a cover body, wherein one of the bottom case and the cover body is provided with an annular recess and the other of the bottom case and the cover body is provided with an annular ring, in a case where the cover body covers the bottom case, the annular ring is inserted in the annular recess, and a mounting cavity is formed between the cover body and the bottom case;
a first sealing member disposed within the annular recess and formed by solidification of an adhesive; and
an antenna body disposed within the mounting cavity and configured to be electrically and/or communicatively connected to an external component via a cable.

2. The antenna according to claim 1, wherein the cover body comprises a base plate and an encircling plate encircling an outer periphery of the base plate, the annular ring is disposed on the base plate and is located within the encircling plate, and in the case where the cover body covers the bottom case, the encircling plate encircles an outer side of the bottom case.

3. The antenna according to claim 2, wherein the base plate is provided with an adhesive encircling plate on an inner side of the annular ring, the adhesive encircling plate and the annular ring form an adhesive recess, the adhesive encircling plate is provided with a first cable hole extending through the adhesive encircling plate to the adhesive recess, the annular ring is provided with a second cable hole extending through the annular ring to the adhesive recess, the cable extends through the first cable hole, the adhesive recess, and the second cable hole from inside to outside in sequence, and the adhesive recess is filled with a second sealing member.

4. The antenna according to claim 3, wherein the bottom case is provided with a support member, and in the case where the cover body covers the bottom case, the adhesive encircling plate abuts the support member.

5. The antenna according to claim 2, wherein the base plate is provided with a connection seat, the connection seat is disposed between the encircling plate and the annular ring and is provided with a screw hole, the bottom case is provided with a mounting hole, and a set screw extends through the mounting hole and is screwed in the screw hole.

6. The antenna according to claim 5, comprising: an attraction member disposed on the bottom case and capable of attracting an external component.

7. The antenna according to claim 6, wherein the attraction member comprises a magnet, a mounting recess is disposed on a side of the bottom shell facing away from the cover body, and the magnet is disposed within the mounting recess.

8. The antenna according to claim 7, comprising: a waterproof film bonded to the bottom case and capable of covering and sealing the mounting recess and the mounting hole.

9. The antenna according to claim 2, wherein the antenna body is secured to the base plate, and a gap is reserved between the antenna body and the bottom case.

10. The antenna according to claim 1, comprising: a buffer member, wherein the cable extends through the buffer member; and the bottom case further comprises a first fixing portion, the cover body is provided with a second fixing portion, and in the case where the cover body covers the bottom case, the buffer member is sandwiched between the first fixing portion and the second fixing portion.

11. The antenna according to claim 3, wherein the antenna body is secured to the base plate, and a gap is reserved between the antenna body and the bottom case.

12. The antenna according to claim 4, wherein the antenna body is secured to the base plate, and a gap is reserved between the antenna body and the bottom case.

13. The antenna according to claim 5, wherein the antenna body is secured to the base plate, and a gap is reserved between the antenna body and the bottom case.

14. The antenna according to claim 2, comprising: a buffer member, wherein the cable extends through the buffer member; and the bottom case further comprises a first fixing portion, the cover body is provided with a second fixing portion, and in the case where the cover body covers the bottom case, the buffer member is sandwiched between the first fixing portion and the second fixing portion.

15. The antenna according to claim 3, comprising: a buffer member, wherein the cable extends through the buffer member; and the bottom case further comprises a first fixing portion, the cover body is provided with a second fixing portion, and in the case where the cover body covers the bottom case, the buffer member is sandwiched between the first fixing portion and the second fixing portion.

16. The antenna according to claim 4, comprising: a buffer member, wherein the cable extends through the buffer member; and the bottom case further comprises a first fixing portion, the cover body is provided with a second fixing portion, and in the case where the cover body covers the bottom case, the buffer member is sandwiched between the first fixing portion and the second fixing portion.

17. The antenna according to claim 5, comprising: a buffer member, wherein the cable extends through the buffer member; and the bottom case further comprises a first fixing portion, the cover body is provided with a second fixing portion, and in the case where the cover body covers the bottom case, the buffer member is sandwiched between the first fixing portion and the second fixing portion.
